(19) United States
(12) Patent Application Publication
(10) Pub. No.: US 2026/0258889 A1
(43) Pub. Date: Sep. 3, 2026

(54) CLAMP WITH RECESS HAVING A GUIDING GROOVE

(71) Applicant: Oetiker Schweiz AG, Horgen (CH)

(72) Inventors: Christoph SCHNEEBERGER, Horgen (CH); Bianca GRIMALDI, Horgen (CH); Steffen Richter, Horgen (CH); Patrick MÜLLER, Horgen (CH)

(73) Assignee: Oetiker Schweiz AG, Horgen (CH)

(21) Appl. No.: 18/872,874

(22) PCT Filed: Jun. 12, 2023
(86) PCT No.: PCT/EP2023/065677

§ 371 Date: Dec. 9, 2024

(30) Foreign Application Priority Data
Jun. 10, 2022 (DE) 10 2022 114 751.7

(51) Int. Cl. F16L 19/00

(52) U.S. Cl. CPC F16L 19/00

(57) ABSTRACT

A band clamp including a clamping band (10) the two end portions (11, 12) of which overlap one another in the closed condition of the band clamp, the clamping band (10) having a tongue (13) arranged at the overlapped inner band portion (11), and a tongue recess (14) provided in the inner side of the overlapping outer band portion (12) and being complementary to the shape of the tongue (13) for receiving the tongue (13), wherein the tongue recess (14) includes two opposing side faces (14d, 14e) connected by a closed roof surface (14f). The roof surface (14f) of the tongue recess (14) includes a longitudinal groove (20) and the tip portion of the tongue (13) includes a protrusion (21) configured to engage in the groove (20).

The invention relates to a clamp made from a flat metal band or strip formed into a loop to be fastened around an object of substantially circular cross-section such as a boot, hose or pipe. Further, the present invention relates particularly to so-called stepless clamps, i.e., clamps having in their closed condition almost no uneven portions or steps at the inner surface.

The document WO 2018/082819 A1 discloses a band clamp including a clamping band the two end portions of which overlap one another in the closed condition of the clamping clip. One of the end portions includes a tongue arranged at the overlapped inner band portion. Such a tongue can be generally defined as an extension of the band in the circumferential direction, said extension having a smaller width than the general band width. The surface of the tongue which is directed radially inwards is configured to be pressed against an outer surface of an object to be clamped, e.g. an outer surface of a boot, pipe or hose. A tongue recess or tongue channel provided in the overlapping outer band portion and being complementary to the shape of the tongue for receiving the tongue. The tongue is inserted into the tongue recess upon tensioning the band clamp, wherein it is guided by lateral side faces of the tongue recess.

A disadvantage encountered with those conventional clamps is that the tongue risks to be tilted or twisted and may not be properly guided into the tongue recess, in particular where the width of the tongue and the tongue recess is small such that the tongue may miss the tongue recess, resulting in an assembly error. The error manifests itself in bunching and ultimately in a reduced sealing performance.

An object of the present invention is to reduce the risk of mounting errors and to save band material.

This object is achieved by the clamp defined in claim 1. The other claims relate to preferred embodiments and a corresponding manufacturing method.

The invention relates to a band clamp including a clamping band. Two end portions of the clamping band overlap one another in the closed condition of the band clamp. The clamping band comprises a tongue arranged at the overlapped inner band portion, and a tongue recess provided in the inner side of the overlapping outer band portion and being complementary to the shape of the tongue for receiving the tongue. The tongue recess includes two opposing, preferably parallel, side faces connected by a closed roof surface and a rear end surface. The tongue recess is a deep-drawn structure in the clamping band and does not include slits or openings.

It is proposed that the roof surface of the tongue recess includes a longitudinal groove and the tip portion of the tongue includes a protrusion configured to engage in the groove. Due to the engagement of the protrusion with the groove, the reliability of the assembly is improved because the engagement aligns and guides the tongue when the latter glides into the tongue recess.

According to the invention, an entry of the tongue recess is formed between transversal or funnel-shaped steps formed in the clamping band. It is proposed that the groove extends outside the tongue recess into an inner surface of the outer band portion beyond these steps. The longitudinal groove is thus formed not only in the roof surface of the tongue recess but continues in the circumferential direction toward the circumferential center of the clamping band. The protrusion can be engaged into the groove in the preassembled delivery condition of the clamp and the portion of the groove beyond the tongue recess guides and aligns the tongue even before the tip of the tongue reaches the entry of the tongue recess. Thereby, the tongue and the tongue recess can be made shorter than the closing travel displacement of the tongue when the clamp is being tightened and band material can be saved.

In a preferred embodiment, a length of the part of the longitudinal groove which continues in the outer band end portion in the circumferential direction toward the circumferential center of the clamping band outside the roof surface of the tongue recess amounts to at least 50% of the length of the tongue recess.

The engagement between the protrusion and the groove is facilitated if the protrusion has rounded edges, preferably hemispherical or hill-shaped. It is further possible that the groove is funnel-shaped, i.e. the width is reduced in the insertion direction of the tongue to further facilitate the alignment.

The advantages of the invention play out particularly well for narrow tongues, i.e. those where a width of the tongue amounts to less than one third of the width of the clamping band. This is because narrow tongues have less mechanical stability and hence show less resistance against an inclined or twisted orientation with respect to the circumferential direction.

Further features and advantages will be apparent from the following description of the embodiments and figures. The entire description, claims and figures disclose features of the invention in specific embodiments and combinations. The person skilled in the art will also consider the features individually and combine them into further combinations or sub-combinations to adapt the invention, as defined in the claims, to his needs or to specific fields of application.

The figures illustrate the following:

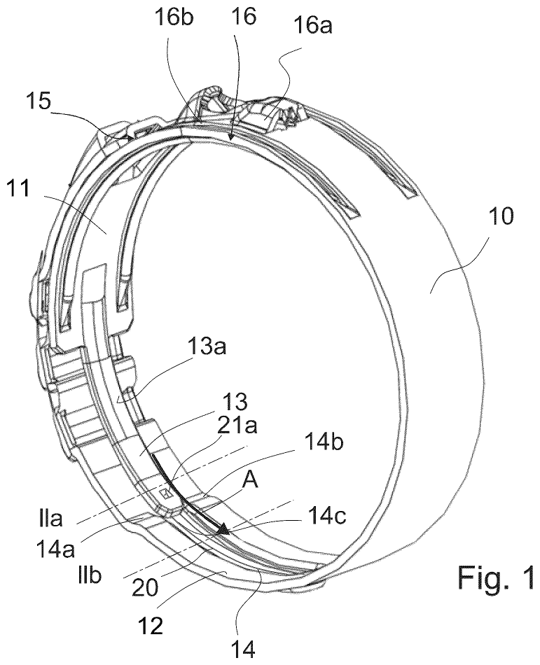

FIG. 1 illustrates a band clamp according to a first embodiment of the invention in a preassembled delivery condition;

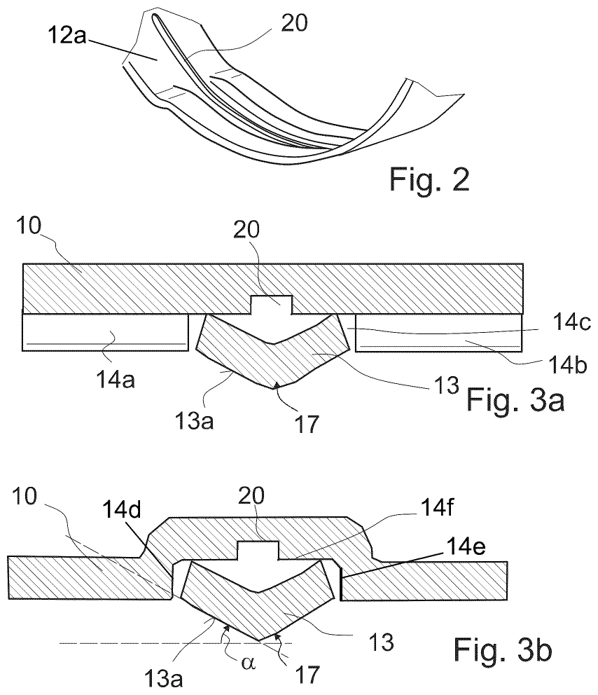

FIG. 2 is a detailed view of a tongue recess and groove of the band clamp in FIG. 1;

FIG. 3a is a sectional view of the band clamp according to FIGS. 1 and 2 along a line IIa in FIG. 1 but in a tightened condition of the clamp;

FIG. 3b is a sectional view of the band clamp according to FIGS. 1 and 2 along a line IIb in FIG. 1 but in a tightened condition of the clamp;

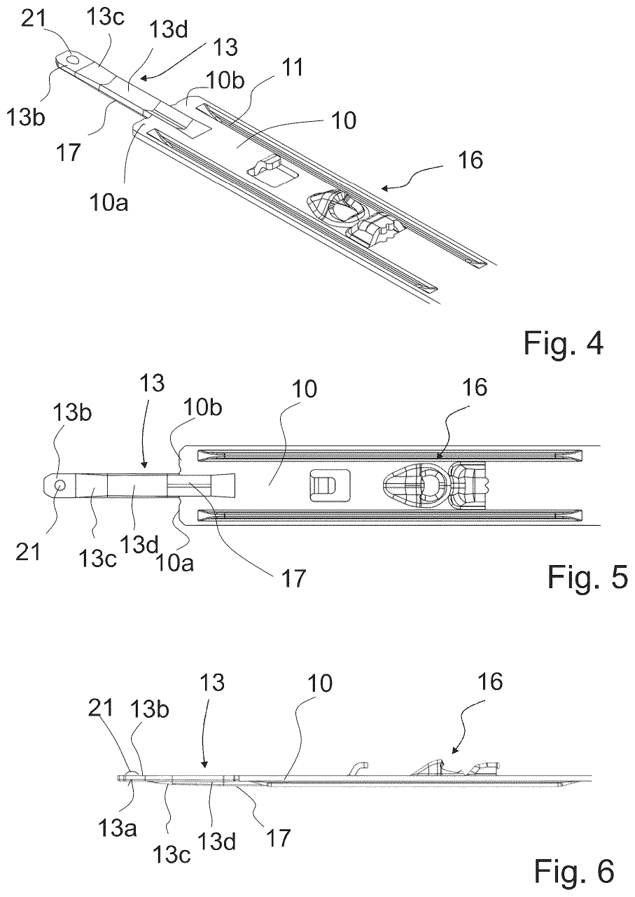

FIG. 4 is a perspective view of the tongue of a band clamp according to the first embodiment in an open configuration of the band;

FIG. 5 is a top view of the tongue of a band clamp according to the first embodiment in an open configuration of the band; and

FIG. 6 is a side view of the tongue in the open configuration of the band.

FIG. 1 shows a band clamp according to a first embodiment of the invention in a closed (pre-assembled) but non-tightened configuration.

The band clamp includes a clamping band 10 with two end portions 11, 12. In the closed condition of the clamp, the two end portions 11, 12 overlap one another. The overlapped inner band portion 11 of the clamping band 10 comprises a tongue 13. The tongue 13 is a portion having a width smaller than a width of the remainder of the band 10, the width amounting preferably to less than 40% of the total width, more preferably less than 30% of the total width. In the embodiment of FIG. 1, the width of the tongue 13 amounts to less than one third of the width of the clamping band 10.

A radially inner surface 13a of the tongue 13 is configured to be pressed against an outer surface of an object to be clamped (not illustrated). The clamping band 10 further includes a tongue recess 14 provided in the overlapping outer band portion 12 and being complementary to the shape of the tongue 13 for receiving the tongue 13.

In the embodiment of FIG. 1, the band clamp is formed as a low profile clamp wherein the other end portion of the clamping band 10 opposite to the tongue 13 comprises an embossed band end structure 15 with openings configured to engage with a corresponding hook 16 on the inner end portion 11 of the clamping band 10, wherein the hook 16 includes a tensioning hook 16a as a gripping structure for a tensioning tool and a load retaining hook 16b for retaining the load once the clamp is closed. However, the invention is not limited to the low profile clamps and can be applied to other types of clamps such as ear clamps, likewise.

When the clamp is tensioned using the tool, the tongue 13 is moved into the tongue recess 14 as illustrated by an arrow A in FIG. 1. During the clamp tightening process, the tongue 13 is mainly guided by the opposing side faces 14d, 14e of the channel-like tongue recess 14. In the shown embodiment, the engagement of the protrusion 21 within the groove 20 mainly serves for keeping the inner band end portion 11 safely in its preassembled position before the tightening process and to assist smooth entry of the tongue end section 13b into the recess 14. However, the clamp may also be formed such that a major part of the tongue guiding is borne by the engagement of the protrusion 21 within the groove 20.

The tongue recess 14 includes an entry opened in a circumferential direction of the clamp to receive the tongue 13. Steps 14a, 14b are formed in the clamping band 10 on both sides of the entry of the tongue recess 14 to bring the outer band portion 12 to a level of the object to be clamped, i.e. substantially the level of the radially inner surface 13a of the tongue 13 in the tightened configuration of the clamp.

As illustrated in FIGS. 3a and 3b, the radially inner surface 13a of the tongue 13 of a band clamp has a transverse profile including at least one projecting portion 17 protruding radially inward. In the tightened configuration of the clamp, the projecting portion 17 results in a locally increased surface pressure improving the sealing performance in the area concerned.

In the embodiment of FIG. 1 to 6, the transverse profile is a V-shaped profile, wherein the central angle of the V-shape constitutes the projecting portion 17. An angle α between each of the lateral legs of the V-shape and a transverse direction in a non-tightened condition of the clamping band 10 is 20° or more and 45° or less. The projecting portion 17 protrudes roughly 0.5 times a thickness of a material of the band 10 over the lateral edges of the tongue 13.

FIG. 4 is a perspective view of the tongue 13 in a flat and open configuration of the band 10, FIG. 5 is a top view of the tongue in the open configuration of the band 10, and FIG. 6 is a side view of the tongue in the open configuration of the band 10. A height of the projecting portion 17 over the lateral edges of the tongue 13 is non-uniform in a longitudinal direction of the tongue 13. The tongue 13 includes a root portion at shoulder portions 10a, 10b where the width of the band 10 is reduced from the full width of the main portion of the clamping band 10 to the width of the tongue 13, wherein the reduction may take place in a stepwise or gradual manner. The tongue 13 further includes an end section 13b on a free end of the tongue 13 opposite to the root portion.

With the exception of the protrusion 21 explained later, the end section 13b has a flat profile and is followed in the longitudinal direction by a wedge section 13c where the height of the projecting portion 17 of the profile increases gradually, a central section 13d where the height of the projecting portion 17 of the profile is preferably constant but may also vary along the length of the tongue. The ridge formed by the profile extends well beyond the shoulder portions 10a, 10b of the band 10 into a section having the full width of the band 10, i.e. the projecting portion 17 is extended beyond the length of tongue into the body of the inner band portion 11. A length of the end section 13b and the wedge section 13c amounts to somewhere between 15 and 30% of the total length of the tongue 13. The lengths of the different sections 13b-13d of the tongue 13 is designed to allow for a sufficient flexibility in the end section 13b, a smooth insertion into the tongue 13 recess by virtue of the wedge section 13b and a suitable placement of the area with increased pressure at an entry of the tongue recess 14 due to the structure and length of the central section 13d.

Returning to FIGS. 1 and 2, tongue recess 14 includes two parallel side faces 14d, 14e connected by a closed roof surface 14f and an end face.

According to the embodiment, the roof surface 14f of the tongue recess 14 includes a longitudinal groove 20 and the end section or tip portion 13b of the tongue 13 includes a protrusion 21 configured to engage in the groove 20 to guide and align the tongue 13 when the band clamp is being tightened.

An entry of the tongue recess 14 is formed between transversal steps 14a, 14b formed in the clamping band 10, wherein the groove 20 extends outside the tongue recess 14 into an inner surface 12a of the outer band portion 12 beyond the transversal steps 14a, 14b. In an alternative embodiment not shown in the drawings, the groove 20 may also be exclusively formed in the tongue recess 14 and not continue beyond the transversal steps 14a, 14b.

In the shown embodiment, a length of a portion of the groove 20 extending into the inner surface 12a of the outer band portion amounts to approximately 80% of a length of the tongue recess 14.

The protrusion 21 is formed by pressing a recess 21a into the inner surface 13a of the tongue 13 at its end portion 13b such that the deformation results in a hemispherical or hill-shaped boss-like protrusion 21 at the outer surface of the tongue 13.

### LIST OF REFERENCE NUMBERS

10 band
10a, 10b shoulder portions
11 inner band end portion
12 outer band end portion
12a inner surface of outer band portion
13 tongue
13a inner surface of the tongue
13b end section
13c wedge section
13d central section
14 tongue recess
14a, 14b steps
14c entry port of tongue recess
14d, 14e side faces
14f top surface
15 structure
16 hook
17 projecting portion
20 groove
21 protrusion
21a recess

1. A band clamp, comprising:
a clamping band (10) having two end portions (11, 12) which overlap one another in a closed condition of the band clamp, the clamping band (10) comprising a tongue (13) arranged at an overlapped inner band portion (11), and a tongue recess (14) provided in an inner side of an overlapping outer band portion (12) and being complementary to a shape of the tongue (13) for receiving the tongue (13), wherein the tongue recess (14) includes two opposing side faces (14d, 14e) connected by a closed roof surface (14f), wherein the roof surface (14f) of the tongue recess (14) includes a longitudinal groove (20) and a tip portion of the tongue (13) includes a protrusion (21) configured to engage in the groove (20), wherein an entry of the tongue recess (14) is formed between transversal steps (14a, 14b) formed in the clamping band (14), wherein the groove (20) extends outside the tongue recess (14) into an inner surface (12a) of the outer band portion (12) beyond the transversal steps (14a, 14b).

2. A band clamp according to claim 1, characterized in that a length of a portion of the groove (20) extending into the inner surface (12a) of the outer band portion (12) amounts to at least 50% of a length of the tongue recess (14).

3. A band clamp according to claim 1, wherein the protrusion (21) has rounded edges.

4. A band clamp according to claim 1, wherein the protrusion (21) is hemispherical or hill-shaped.

5. A band clamp according to claim 1, wherein a width of the tongue (13) amounts to less than one third of the width of the clamping band (10).

6. A band clamp according to claim 1, characterized in that the two opposing side faces (14d, 14e) are parallel to each other.
